(19) United States
(12) Patent Application Publication
(10) Pub. No.: US 2023/0173621 A1
(43) Pub. Date: Jun. 8, 2023

(54) WELDING FILLER MATERIAL

(71) Applicant: VDM Metals International GmbH, Werdohl (DE)

(72) Inventor: Martin WOLF, Dortmund (DE)

(73) Assignee: VDM Metals International GmbH, Werdohl (DE)

(21) Appl. No.: 18/105,329

(22) Filed: Feb. 3, 2023

Related U.S. Application Data
(62) Division of application No. 16/753,053, filed on Apr. 2, 2020.

(30) Foreign Application Priority Data
Dec. 8, 2017 (DE) 10 2017 129 218.7

(51) Int. Cl. B23K 35/30; B23K 35/02; C22C 19/05

(52) U.S. Cl. CPC B23K 35/304; B23K 35/0261; C22C 19/055

(57) ABSTRACT

A welding filler material includes (in wt.-%): C 0.01-0.05%; N 0.05-0.10%; Cr 20.0-23.0 %; Mn 0.25-0.50 %; Si 0.04-0.10 %; Mo 8.0-10.5 %; Ti 0.75-1.0 %; Nb 3.0-5.0%; Fe max. 1.5%; Al 0.03-0.50%; W 4.0-5.0%; Ta max. 0.5%; Co max. 1.0%; Zr 0.10-0.70% Ni remainder; and impurities resulting from the smelting process.

### CROSS REFERENCE TO RELATED APPLICATIONS

This application is a divisional of and Applicant claims priority under 35 U.S.C. §§ 120 and 121 of U.S. patent application Ser. No. 16/753,053 filed on Apr. 2, 2020, which application is a national stage application under 35 U.S.C. § 371 of PCT Application No. PCT/DE2018/100933 filed on Nov. 15, 2018, which claims priority under 35 U.S.C. § 119 from German Patent Application No. 10 2017 129 218.7 filed on Dec. 8, 2017, the disclosures of each of which are hereby incorporated by reference. A certified copy of priority German Patent Application No. 10 2017 129 218.7 is contained in parent U.S. application Ser. No. 16/753,053. The International Application under PCT article 21(2) was not published in English.

### BACKGROUND OF THE INVENTION

### 1. Field of the Invention

The invention relates to a welding filler material.

### 2. Description of the Related Art

For metallurgical reasons, welding of non-alloyed and low-alloyed steels, which were provided with roll cladding, explosion cladding or weld cladding made from high-alloyed steels or nickel alloys, requires a fully austenitic weld metal under certain conditions and taking into consideration dilution with the C-steel substrate material. Use of welding filler materials on a nickel basis is indispensible in such cases. In order for elastic and plastic elongations not to preferentially concentrate in the weld seam in the case of mechanical stresses transverse to the weld seam, and thereby lead to component failure in the weld seam, the weld metal on a nickel basis must furthermore demonstrate a higher yield strength than the surrounding base material.

When welding cladded sheet metal, it is therefore necessary, under certain conditions, to use a welding filler material on the basis of a nickel material, which demonstrates a higher yield strength in the weld metal than the surrounding carbon steel. Since the development of carbon steels has led to higher and higher yield strengths by means of refinements of the chemical composition and/or by means of optimization of the production process, it is necessary to also use welding filler material on a nickel basis, which keeps in step with the developments in the field of carbon steels.

Until now, the welding filler material FM 625 (ISO 18274-S NI 06625) has been used for connection-welding of cladded metal sheets. This material has a yield strength of approximately 510 MPa to 580 MPa in the weld metal, and is suitable for welding of carbon steels having a yield strength up to 460 MPa, taking into consideration the required safety reserve.

WO 2015/153905 A1 discloses a high-strength Ni—Cr—Mo—W—Nb—Ti welding product having (in wt.-%) 17.0-23.0% chromium, 5.0-12.0% molybdenum, 3.0-11.0% tungsten, 3.0-5.0% niobium, 0-2.0% tantalum, 1.2-3.0% titanium, 0.005-1.5% aluminum, 0.0005-0.1% carbon, less than 2% iron, less than 5% cobalt, remainder nickel, wherein the nickel content lies in the range between 56 and 65%. The weld metal is supposed to have a minimum yield strength of 496 MPa.

Due to the high minimum titanium content, insufficient notched bar impact work is achieved for this material, since titanium represents an element that strongly forms phases with the base element nickel (gamma' phase). As a result, although the yield strength of the weld metal is increased, it is known that hardening by way of the gamma' phase leads to severe embrittlement of the material. Furthermore, the effect of the titanium as a gamma' phase formation agent is greatly dependent on the heat conduction of the welding process, due to the reaction kinetics that are triggered by the weld heat. Therefore the values that can be achieved for the yield strength are subject to great variations, and thereby the guaranteed minimum yield strength has to be greatly restricted for practical use.

### SUMMARY OF THE INVENTION

The invention is based on the task of making available an alternative welding filler material, which demonstrates not only good weldability and corrosion resistance but also improved notched bar impact work and a higher yield strength.

This task is accomplished by a welding filler material having (in wt.-%)

| | |
|---|---|
| C | 0.01-0.05% |
| N | 0.05-0.10% |
| Cr | 20.0-23.0% |
| Mn | 0.25-0.50% |
| Si | 0.04-0.10% |
| Mo | 8.0-10.5% |
| Ti | 0.75-1.0% |
| Nb | 3.0-5.0% |
| Fe | max. 1.5% |
| Al | 0.03-0.50% |
| W | 4.0-5.0% |
| Ta | max. 0.5% |
| Co | max. 1% |
| Zr | 0.10-0.70% |

Ni remainder, and impurities resulting from the smelting process.

Advantageous further developments of the material according to the invention can be found in the dependent claims.

The invention relates to a welding filler material composed of a nickel-based alloy, which is suitable for producing weld metals having a very high mechanical yield strength. The welding filler material achieves this very high yield strength in the weld metal without subsequent further heat treatment.

The element iron is indicated at max. 1.5%, wherein contents 1.2%, in particular 0.9% are also possible.

According to a further idea of the invention, the material has a yield strength, Rp 0.2 above 610 MPa in the thermally untreated weld metal. The material according to the invention differs from the state of the art by means of the modified titanium and zirconium contents, wherein the element nitrogen is intentionally alloyed in here.

In the studies of the material according to the invention, it was found that a titanium content of 0.75-1.0% on the one hand makes a contribution to an increase in the yield strength, but does not bring with it any excessive embrittlement of the weld metal. Furthermore, it was found that the dependence of the mechanical/technological values in the weld metal is independent of the heat management during welding, to a great extent.

The element zirconium is indicated in a range between 0.10% and 0.70%. Contents in the range between 0.30% and 0.65% are preferred ranges here. In this connection, studies have shown that Zr preferentially forms carbides with the alloy element C, which carbides are present in finely dispersed form and thereby bring about an extraordinary increase in strength (FIG. 2). This recognition is new in that until now, Zr has been used as an alloy element only in the case of high-temperature alloys and heat conductor alloys. In this connection, it is known that in the case of high-temperature alloys and heat conductor alloys, Zr can improve the long-term high-temperature resistance and adhesion of scale layers. However, until now it has not become known that Zr is able to significantly improve the mechanical properties in the case of room temperatures and temperatures below that of a welding filler material.

Nitrogen is indicated between 0.05% and 0.10%. N is an element that very greatly increases the pitting corrosion resistance and crevice corrosion resistance of the material when dissolved interstitially. However, N also forms finely dispersed TiN with Ti (FIG. 2). Studies have shown that the yield strength increases greatly as the result of the combination of nitrogen and titanium, due to the formation of titanium nitride. Furthermore, the addition of nitrogen prevents Ti from forming the gamma' phase with Ni, which leads to the disadvantages mentioned above.

It was surprisingly found in the studies that in addition to the elements Cr, Mo, Nb, which harden mixed crystals, an effect with which the target minimum yield strength can be reached in the thermally untreated weld metal, with simultaneously good ductility, only by the sum of the carbide-forming and nitride-forming alloy elements Zr, N, C, Ti, Nb.

Impurities are contained in the alloy according to the invention as follows:

| | |
|---|---|
| P | max. 0.05% |
| S | max. 0.01% |
| V | max. 0.05% |

The combination of high yield strength and good ductility is achieved if the following ratios (information in mass-%) of the elements Zr, N, c, Ti, Nb are adhered to:
[Zr]/[C]>7, more advantageously>10
[Ti]/[N]>10
[Nb]/[C]>100, in particular >150

The addition of manganese improves heat crack resistance by means of the formation of MnS. Furthermore, it was also found that manganese also makes a contribution to increasing the yield strength in the weld metal.

In the studies of the material according to the invention, it was found that at least 0.04% silicon are required for good weldability, but that silicon is not allowed to be greater than 0.10%, so as not to worsen the heat crack resistance.

It was possible to hot-roll laboratory ingots produced from the composition according to the invention, with batch sizes of 100 kg (Table 2), without problems, wherein it was possible to determine that the hot-rolling temperature should preferably lie between 950° C. and 1180° C. Subsequently, it was possible to further process and finish the hot-rolled laboratory ingots mechanically, to produce the desired dimensions.

Thin square rods having an edge length of approximately 4 mm were cut from the rolled laboratory sheets having the compositions in Table 1 and 2. Using these square rods, a weld metal sample was produced according to ISO 15792-1, by means of the TIG method, and subsequently the mechanical/technological tests were conducted. The results of the studies are listed in Table 1 and 3.

TABLE 1
Alloys studied (laboratory batches - 10 kg)

| | | | | | | | | | | KV2 |
|---|---|---|---|---|---|---|---|---|---|---|
| Lab. | | | | | | | | Rp0.2 | KV2 | (−196° |
| No. | W | Co | C | Mn | Ti | N | Zr | [MPa] | (RT, J) | C., J) |
| 250441 | 3 | 15 | | | | | | 586 | 105 | 74 |
| 250442 | 3 | 10 | | | | | | 552 | 112 | 55 |
| 250443 | 4 | 10 | | | | | | 537 | 105 | 89 |
| 250445 | 3 | 10 | 0.03 | | | | | 561 | 98 | 73 |
| 250446 | 3 | 5 | 0.03 | | | | | 524 | 94 | 80 |
| 250447 | | | | 10 | 1.5 | | | 644 | 24 | 14 |
| 250478 | | | | | 0.5 | 0.5 | | 586 | 100 | 84 |
| 250479 | | | | | 1 | 0.5 | | 612 | 77 | 75 |
| 250484 | | | | | 1 | 0.2 | | 601 | 67 | 59 |
| 250486 | 3 | | | | 1 | 0.1 | | 578 | 81 | 54 |
| 250487 | 3 | | 0.03 | | | 0.1 | 0.5 | 644 | 97 | 87 |
| 250488 | 3 | 5 | 0.03 | | | 0.1 | 0.2 | 623 | 105 | 89 |

TABLE 2
Smelt analysis of the pilot plant batch PV864 (100 kg)

| Chem. Element | PV 864 |
|---|---|
| C | 0.020 |
| Si | 0.070 |
| Mn | 0.350 |
| P | 0.010 |
| S | 0.0020 |
| Al | 0.0700 |
| Cu | 0.0100 |
| Cr | 22.00 |
| Ni | 58.00 |
| Mo | 9.300 |
| V | 0.020 |
| Ti | 0.900 |
| Nb | 3.300 |
| Co | 0.0300 |
| Fe | 1.00 |
| W | 4.40 |
| N | 0.0670 |
| Zr | 0.60 |

TABLE 3
Mechanical/technical values of the pure weld
metal from the pilot plant batch PV864

| | Rp0.2 | RP1.0 | RM | A5 | KV2 |
|---|---|---|---|---|---|
| PV 864 | (Mpa) | (Mpa) | (Mpa) | (%) | (RT, J) |
| weld | 654 | 701 | 877 | 34 | 121 |
| metal | | | | | |
| sample 1 | | | | | |
| weld | 646 | 690 | 848 | 31 | 112 |
| metal | | | | | |
| sample 2 | | | | | |

What is claimed is:

1. A method of using a welding filler material to weld a base material, the method comprising:
providing the welding filler material, wherein the welding filler material comprises and alloy having (in wt.-%)

| | |
|---|---|
| C | 0.01-0.05% |
| N | 0.05-0.10% |
| Cr | 20.0-23.0% |
| Mn | 0.25-0.50% |
| Si | 0.04-0.10% |
| Mo | 8.0-10.5% |
| Ti | 0.75-1.0% |
| Nb | 3.0-5.0% |
| Fe | max. 0.9% |
| Al | 0.03-0.50% |
| W | 4.0-5.0% |
| Ta | max. 0.5% |
| Co | max. 1.0% |
| Zr | 0.10-0.70% |

the welding filler material containing the following impurities

| | |
|---|---|
| P | max. 0.05% |
| S | max. 0.01% |
| V | max. 0.05% |

Ni remainder, and impurities, wherein the welding filler material has a yield strength Rp 0.2>610 MPa in a thermally untreated weld metal, and wherein the alloy satisfies the following conditions:
Zr/C>7
Nb/C>100; and
adding the welding filler material to the base material in a welding process to form a weld seam in the base material.

2. The method according to claim 1, wherein the welding material has (in wt.-%)

| | |
|---|---|
| Zr | 0.3-0.65%. |

3. The method according to claim 1, wherein the alloy satisfies the following condition:
Ti/N>10.

4. The method according to claim 1, wherein the welding filler material has a yield strength Rp 0.2>640 MPa, in the thermally untreated weld metal.

5. The method according to claim 1, wherein the alloy satisfies the following condition:
Zr/C>10.

6. The method according to claim 1, wherein the alloy satisfies the following condition:
Nb/C>150.
